(19) United States
(12) Patent Application Publication
(10) Pub. No.: US 2025/0351092 A1
(43) Pub. Date: Nov. 13, 2025

(54) POWER HEADROOM REPORTING FOR SOUNDING REFERENCE SIGNAL TRANSMISSIONS

(71) Applicant: LENOVO (SINGAPORE) PTE. LTD., Singapore (SG)

(72) Inventor: Colin Frank, Park Ridge, IL (US)

(73) Assignee: LENOVO (SINGAPORE) PTE. LTD., Singapore (SG)

(21) Appl. No.: 18/661,691

(22) Filed: May 12, 2024

(51) Int. Cl. H04W 52/32; H04W 52/36

(52) U.S. Cl. CPC H04W 52/325; H04W 52/365; H04W 52/367

(57) ABSTRACT

Various aspects of the present disclosure relate to power headroom reporting for sounding reference signal transmissions. A device (e.g., a user equipment (UE)) transmits (e.g., to a base station) an indication of differences in insertion losses between a reference sounding reference signal (SRS) port and each of one or more additional SRS ports at the device. The device also transmits a power headroom report for less than all SRS ports in a set of SRS ports at the device that include the reference SRS port and the one or more additional SRS ports. This allows the base station to determine the transmit power for each of the SRS ports from only the one power headroom report.

### TECHNICAL FIELD

The present disclosure relates to wireless communications, and more specifically to power headroom reporting for sounding reference signal transmissions.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication. The UE transmits an indication of differences in insertion losses between a reference sounding reference signal (SRS) port and each of one or more additional SRS ports; transmits a power headroom report for less than all SRS ports in a set of SRS ports that include the reference SRS port and the one or more additional SRS ports.

In some implementations of the method and apparatuses described herein, the reference SRS port comprises an SRS port of the UE having a smallest insertion loss. Additionally or alternatively, the UE transmits the power headroom report for one SRS port of the set of SRS ports having a smallest insertion loss. Additionally or alternatively, the power headroom report includes a configured maximum power for the SRS port having the smallest insertion loss. Additionally or alternatively, the indication of differences in insertion losses comprises differences in insertion losses between the reference SRS port and each of the one or more additional ports. Additionally or alternatively, the indication of differences in insertion losses comprises differences in configured maximum power values between the reference SRS port and each of the one or more additional ports. Additionally or alternatively, the UE transmits an identity of the SRS reference port. Additionally or alternatively, the UE transmits, in response to a change in SRS port mappings, an updated indication of differences in insertion losses between the reference SRS port and each of one or more additional SRS ports.

Some implementations of the method and apparatuses described herein may further include a processor for wireless communication. The processor transmits an indication of differences in insertion losses between a reference SRS port and each of one or more additional SRS ports; transmits a power headroom report for less than all SRS ports in a set of SRS ports that include the reference SRS port and the one or more additional SRS ports.

In some implementations of the method and apparatuses described herein, the reference SRS port comprises an SRS port, of a UE that includes the processor, having a smallest insertion loss. Additionally or alternatively, the processor transmits the power headroom report for one SRS port of the set of SRS ports having a smallest insertion loss. Additionally or alternatively, the power headroom report includes a configured maximum power for the SRS port having the smallest insertion loss. Additionally or alternatively, the indication of differences in insertion losses comprises at least one of differences in insertion losses between the reference SRS port and each of the one or more additional ports, or differences in insertion losses comprises differences in configured maximum power values between the reference SRS port and each of the one or more additional ports. Additionally or alternatively, the processor to transmit an identity of the SRS reference port. Additionally or alternatively, the processor transmits, in response to a change in SRS port mappings, an updated indication of differences in insertion losses between the reference SRS port and each of one or more additional SRS ports.

Some implementations of the method and apparatuses described herein may further include a base station for wireless communication. The base station receives an indication of differences in insertion losses between a reference SRS port of a UE and each of one or more additional SRS ports of the UE; receives a power headroom report for less than all SRS ports in a set of SRS ports that include the reference SRS port and the one or more additional SRS ports.

In some implementations of the method and apparatuses described herein, the base station receives the power headroom report for one SRS port of the set of SRS ports having a smallest insertion loss. Additionally or alternatively, the indication of differences in insertion losses comprises at least one of differences in insertion losses between the reference SRS port and each of the one or more additional ports, or differences in insertion losses comprises differences in configured maximum power values between the reference SRS port and each of the one or more additional ports.

Some implementations of the method and apparatuses described herein may further include a method performed by a UE, the method comprising: transmitting an indication of differences in insertion losses between a reference SRS port and each of one or more additional SRS ports; and transmitting a power headroom report for less than all SRS ports in a set of SRS ports that include the reference SRS port and the one or more additional SRS ports.

In some implementations of the method and apparatuses described herein, the method further comprises: wherein the reference SRS port comprises an SRS port of the UE having a smallest insertion loss.

### BRIEF DESCRIPTION OF THE DRAWINGS

FIG. 1 illustrates an example of a wireless communications system in accordance with aspects of the present disclosure.

FIG. 2 illustrates an example of power headroom reporting for sounding reference signal transmissions in accordance with aspects of the present disclosure.

FIG. 3 illustrates an example of compensation of implementation losses in accordance with aspects of the present disclosure.

FIG. 4 illustrates an example of SRS output power versus power control with and without compensation in accordance with aspects of the present disclosure.

FIG. 5 illustrates an example of power difference between SRS ports versus power control with compensation in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by a NE in accordance with aspects of the present disclosure.

### DETAILED DESCRIPTION

For downlink multiple input multiple output (MIMO) implemented without a codebook, for time division duplex (TDD) bands the downlink channel is estimated by a NE (e.g., gNB) based on uplink SRS transmissions. With the assumption of channel reciprocity, the NE (e.g., gNB) estimates the downlink channel to be the same as the uplink channel.

Many of the UE antennas that transmit SRS are receive-only antennas except when transmitting SRS. As a result, these antennas that are receive only except when transmitting SRS do not have dedicated power amplifiers (PAs) and share a power amplifier (PA) with a transmit/receive antenna. As a result, there can be large signaling and trace losses (also referred to as insertion losses) between the PA and the receive-only antenna. Furthermore, the insertion losses can be different for different antennas. For these receive-only antennas, very large insertion losses are allowed, for example, in excess of 7.5 decibel (dB). These large and unknown to the NE (e.g., gNB) insertion losses, can result in incorrect channel estimation that can negatively impact the downlink scheduling decisions, resulting in a loss of throughput. Since the actual power relaxations may be much less than the maximum value allowed, the NE (e.g., gNB) cannot simply assume that the maximum power relaxations are used by the UE.

The UE transmits SRS on one or more SRS ports. An SRS port refers to an antenna port that is used to transmit the SRS. Each SRS port can be assigned or mapped to one of multiple antennas of the UE, and this assignment or mapping can be changed over time by the UE or by command from the NE (e.g., gNB). An antenna port refers to a logical entity and is defined such that the channel over which a symbol on the antenna port is conveyed can be inferred from the channel over which another symbol on the same antenna port is conveyed.

The techniques discussed herein reduce the UE signaling used for the NE (e.g., gNB) to be able to correct the downlink channel estimates. The techniques discussed herein include the UE determining and transmitting to the NE (e.g., gNB) an indication of differences in insertion losses between a reference SRS port and one or more additional SRS ports. This indication of differences in insertion losses can be, for example, the differences in insertion losses between the reference SRS port and each of the one or more additional ports, or the differences in configured maximum power values between the reference SRS port and each of the one or more additional ports. The reference SRS port can be any of the SRS ports of the UE, such as an SRS port having a smallest insertion loss. These insertion losses can be reported to the NE (e.g., gNB) if they change, which may happen if the port mappings are changed. These insertion losses need not be reported to the NE (e.g., gNB) every time a power headroom report is reported to the NE (e.g., gNB). In addition, on each SRS occasion, the UE reports the power headroom for one SRS port (e.g., the SRS port with the smallest insertion loss). This indication of differences in insertion losses and the power headroom report for one SRS port, including the maximum configured power for the SRS port, is sufficient for the NE (e.g., gNB) to compute the transmit power for each of the SRS ports from only the one power headroom report in the case that the UE compensates the SRS power imbalance up to a configured maximum power (PCMAX) for the port, and in the case that the UE does not compensate the SRS power imbalances.

The techniques discussed herein reduce the UE signaling used for the NE (e.g., gNB) to correct the SRS-based estimate of the downlink channel. For example, the NE (e.g., gNB) is able to correct the SRS based channel estimate using a power headroom report for a single SRS port in contrast to solutions that require transmission of a power headroom report for all of the (up to 8) SRS ports.

Aspects of the present disclosure are described in the context of a wireless communications system.

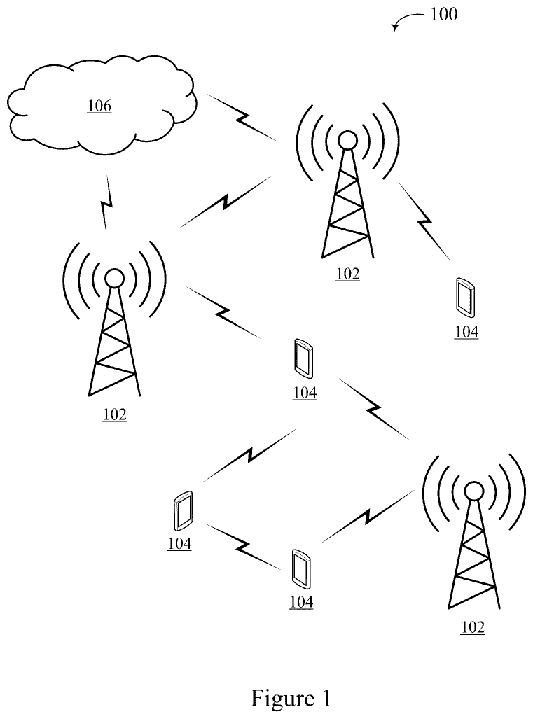

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., Econtrol information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A UE 104 transmits to the NE 102 (e.g., a gNB) an indication of differences in insertion losses between a reference SRS port and each of one or more additional SRS ports. This indication of differences in insertion losses can be, for example, at least one of the differences in insertion losses between the reference SRS port and each of the one or more additional ports or differences in configured maximum power values between the reference SRS port and each of the one or more additional ports. The UE 102 also transmits to the NE 102 (e.g., a gNB) a power headroom report for less than all SRS ports in a set of SRS ports that include the reference SRS port and the one or more additional SRS ports. The reference SRS port can be, for example, an SRS port of the UE 104 having a smallest insertion loss, and the power headroom report can include a configured maximum power for the SRS port having the smallest insertion loss. This information allows the NE 102 (e.g., a gNB) to compute the transmit power for each of the SRS ports.

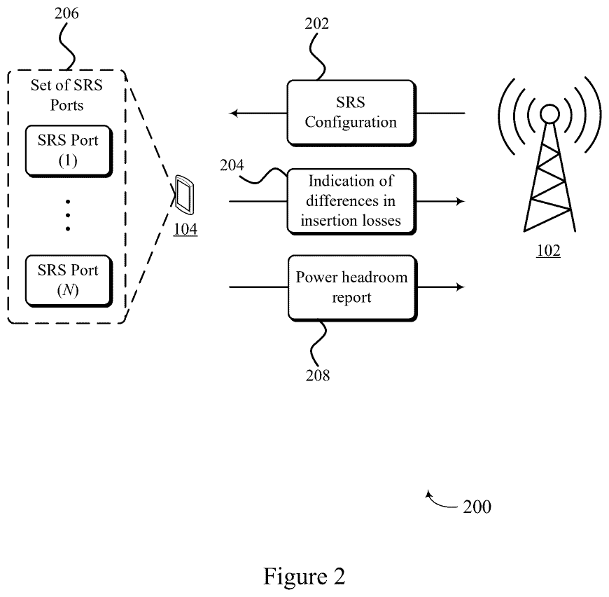

FIG. 2 illustrates an example 200 of power headroom reporting for sounding reference signal transmissions in accordance with aspects of the present disclosure. In the example 200, an NE 102 (e.g., a gNB) transmits an SRS configuration 202 to a UE 104, indicating to the UE 104 when and how to transmit SRS. The UE 104 transmits an indication of differences in insertion losses 204, such as at least one of insertion losses between a reference SRS port of the set or SRS ports 206 and each of one or more additional ports in the set of SRS ports 206, or differences in configured maximum power values between the reference SRS port of the set of SRS ports 206 and each of one or more additional ports in the set of SRS ports 206 to the NE 102. The reference SRS port can be any of the SRS ports 206, such as the SRS port with the smallest insertion loss.

The UE 104 also transmits to the NE 102 a power headroom report 208 in response to various events or at various times, which may be configured by the NE 102. The power headroom report indicates how much transmission power is left for the UE 104 to use in addition to the amount of transmission power already being used. The power headroom report is transmitted for one SRS port of the UE 104 (e.g., the SRS port with the smallest insertion loss). The power headroom report is for less than all SRS ports in the set of SRS ports 206, e.g., for a single SRS port of the SRS ports 206. Furthermore, the indication of differences in insertion losses 204 need not be reported to the NE 102 every time a power headroom report 208 is reported to the NE 102. Rather, the indication of differences in insertion losses 204 can be reported to the NE 102 in response to a change in the insertion losses, such as change in the SRS port to antenna mappings.

The techniques discussed herein are directed to the issue of insertion loss imbalance across SRS ports. These additional insertion losses arise from transmitting SRS from antenna ports that are receive only except for SRS transmission.

With respect to the impact of SRS power relaxations on power control behavior, the UE 104 is allowed to specify its maximum configured power PC_{MAX,f,c} in the range

$${P}_{CMAX \_ L , f , c} \leq {P}_{CMAX , f , c} \leq H , {P}_{CMAX \_ H , f , c} with$$

$${P}_{CMAX \_ L , f , c} = MIN \{ {P}_{EMAX , c} - Δ {T}_{C , c} , ( {P}_{PowerClass} - Δ {P}_{PowerClass} + Δ {P}_{PowerBoost} ) - MAX ( MAX ( {MPR}_{c} + Δ {MPR}_{c} , A - {MPR}_{C} ) + Δ {T}_{IB , c} + Δ {T}_{C , c} + Δ {T}_{RxSRS} , P - {MPR}_{c} ) \}$$

$${P}_{CMAX \_ H , f , c} = MIN \{ {P}_{EMAX , c} , {P}_{PowerClass} - Δ {P}_{PowerClass} + Δ {P}_{PowerBoost} \} ,$$

where PC_{MAX_H,f,c} is the upper bound on maximum configured power and PC_{MAX_L,f,c} is the lower bound on maximum configured power. Because different SRS ports can have different values of ΔT_{RxSRS}, each SRS port can set its own maximum configured power. Further, since the configured maximum power PC_{MAX,f,c} is not required to be equal to PC_{MAX_L,f,c}, the configured maximum power PC_{MAX,f,c} and PC_{MAX,f,c} can be different for two SRS ports even if they have the same value of ΔT_{RxSRS}.

The allowed power relaxations can be divided into two types, including Type 1: MPR_{c}, ΔMPR_{c}, A-MPR_{c}, P-MPR_{c}, ΔP_{PowerClass}, ΔP_{PowerBoost}; and Type 2: ΔT_{IB,c}, ΔT_{C,c}, ΔT_{RxSRS}.

Type 1 maximum power relaxations are taken by the UE 104 in order meet emissions, regulatory, or other requirements. The UE 104 knows both the values of these relaxations and the conditions under which they are taken. The UE 104 may take power relaxations less than the maximum allowed, but if it does, then the UE 104 knows the values.

Type 2 power relaxations are not applied by the UE 104 but are the result of implementation losses. These power relaxations exist at all output power levels unless compensated by the UE 104. The value of ΔT_{C,c} is 1.5 dB at the band edge and is otherwise 0. The value of ΔT_{IB,c} is typically less than 0.5 dB, but it can be as large as 1.5 dB.

The allowed relaxation ΔT_{C,c} is frequency dependent, while the relaxation ΔT_{IB,c} is band combination dependent. The allowed value of these relaxations is not port dependent, but the actual values could possibly be port dependent depending on the architecture and the filters used. The allowed relaxation ΔT_{RxSRS} is port dependent and so can be denoted ΔT_{RxSRS,j} for the j-th SRS port.

Given that there are three types of power relaxations that are allowed for implementation losses, ΔT_{C,c}, ΔT_{IB,c}, and ΔT_{RxSRS,j}, one consideration is whether a UE 104 is expected to compensate all of these power relaxations below P_{CMAX}, or only expected to compensate ΔT_{RxSRS,j}. Another consideration is if a UE 104 indicates that it compensates the SRS power relaxations ΔT_{RxSRS,j} below P_{CMAX}, is the UE 104 expected or required to compensate all of the Type 2 power relaxations ΔT_{C,c}, ΔT_{IB,c}, and ΔT_{RxSRS,j}.

With respect to signaling and compensation of SRS power relaxation, let

$$Δ {T}_{RxSRS , j}^{A}$$

denote the actual insertion loss associated with the j-th antenna port. For two antenna ports i and j, let the difference in the configured maximum power between two antenna ports be defined as δ_{i,j}, where

$${δ}_{i , j} = {P}_{CMAX , f , c} ( i ) - {P}_{CMAX , f , c} ( j ) ,$$

and P_{CMAX_L,f,c}(i) denotes the P_{CMAX} value for the i-th antenna port. It can typically be expected that

$${P}_{CMAX , f , c} ( i ) - {P}_{CMAX , f , c} ( j ) = Δ {T}_{RxSRS , j}^{A} - Δ {T}_{RxSRS , i}^{A}$$

so that

$${δ}_{i , j} = Δ {T}_{RxSRS , j}^{A} - Δ {T}_{RxSRS , i}^{A} ,$$

though this is not a requirement. For example, a different MPR or A-MPR relaxation (less than the maximum allowed) could be chosen for the i-th antenna port than for the j-th antenna port, but in one or more implementations this behavior is not expected.

It is expected that the difference between the configured maximum power for two ports i and j given by

$${δ}_{i , j} = {P}_{CMAX , f , c} ( i ) - {P}_{CMAX , f , c} ( j )$$

is fixed and is independent of the resource block (RB) allocation and is equal to the difference in SRS insertion loss so that

$${δ}_{i , j} = Δ {T}_{RxSRS , j}^{A} - Δ {T}_{RxSRS , i}^{A} .$$

The N antenna ports used for SRS transmission are numbered such that

$${δ}_{1 , j} \geq 0 for all 1 \leq j \leq N .$$

For example, port 1 could be defined for an SRS port for which no relaxation is allowed. If port 1 is used, this implies that

$${P}_{CMAX , f , c} ( 1 ) - {P}_{CMAX , f , c} ( j ) \geq 0 for all 1 \leq j \leq N$$

or equivalently, that

$${P}_{CMAX , f , c} ( 1 ) \geq {P}_{CMAX , f , c} ( j ) for all 1 \leq j \leq N$$

For each SRS occasion, it is assumed that the UE 104 signals two of the three quantities for port 1: i) the transmitted power p_{t,1}; ii) the maximum configured power P_{CMAX,f,c} (i); iii) the power headroom for port p_{H,1}. These three quantities have the relationship

$${P}_{CMAX , f , c} ( 1 ) = {p}_{t , 1} + {p}_{H , 1} .$$

For the case in which the UE 104 signals the N−1 difference δ_{i,j}, 2≤j≤N, there are two alternative cases for handling insertion losses.

In Case 1, the UE 104 compensates the transmit power for the insertion losses for each antenna port i up to P_{CMAX,f,c}(i). In Case 2, the UE 104 does not compensate the transmit power for the insertion losses.

For Case 1, it can be assumed that the insertion loss that is compensated is the actual SRS insertion loss

$$Δ {T}_{RxSRS , j}^{A} ,$$

or it can be assumed that the compensated insertion loss is the sum of the actual SRS insertion loss

$$Δ {T}_{RxSRS , j}^{A}$$

and the other insertion losses ΔT_{C,c} and ΔT_{IB,c}. Unless ΔT_{C,c} and ΔT_{IB,c} are port dependent, it should still be the case that

$${P}_{CMAX , f , c} ( i ) - {P}_{CMAX , f , c} ( j ) = Δ {T}_{RxSRS , j}^{A} - Δ {T}_{RxSRS , i}^{A} = {δ}_{i , j} .$$

For both Case 1 and Case 2, the transmit power for any port j can be determined from the difference in the insertion loss δ_{1,j}, the transmit power on the first antenna port, p_{t,1}, and the configured maximum power for the first antenna port P_{CMAX,f,c}(1)

For Case 1, the UE 104 compensates the insertion loss for the j-th antenna port up to PCMAX,f,c (j) for the j-th antenna port which can be expressed as

$${P}_{CMAX , f , c} ( j ) = {P}_{CMAX , f , c} ( 1 ) - ( {P}_{CMAX , f , c} ( 1 ) - {P}_{CMAX , f , c} ( j ) ) = {P}_{CMAX , f , c} ( 1 ) - {δ}_{1 , j} ,$$

since the UE 104 compensates the insertion loss, the transmit power for the j-th antenna port is given by

$${p}_{t , j} = \{ \begin{matrix}{p}_{t , 1} & {p}_{t , 1} \leq {P}_{CMAX , f , c} ( 1 ) - {δ}_{1 , j} \\ {P}_{CMAX , f , c} ( 1 ) - {δ}_{1 , j} & {p}_{t , i} > {P}_{CMAX , f , c} ( 1 ) - {δ}_{1 , j}\end{matrix} .$$

It should be noted that this approach only works if

$${P}_{CMAX , f , c} ( 1 ) \geq {P}_{CMAX , f , c} ( j ) for all \leq j \leq N .$$

Otherwise, there exists an index j such that

$${P}_{CMAX , f , c} ( j ) > {P}_{CMAX , f , c} ( 1 )$$

from which it follows that δ_{1,j}<0. Since

$${p}_{t , 1} \leq {P}_{CMAX , f , c} ( 1 )$$

and since δ_{1,j}<0, it must also be true that

$${p}_{t , 1} \leq {P}_{CMAX , f , c} ( 1 ) - {δ}_{1 , j} .$$

In this case in which the insertion losses are compensated,

$${p}_{t , j} = \{ \begin{matrix}{p}_{t , 1} & {p}_{t , 1} \leq {P}_{CMAX , f , c} ( 1 ) - {δ}_{1 , j} \\ {P}_{CMAX , f , c} ( 1 ) - {δ}_{1 , j} & {p}_{t , i} > {P}_{CMAX , f , c} ( 1 ) - {δ}_{1 , j}\end{matrix} \} = {p}_{t , 1} .$$

However, since it was assumed that

$${P}_{CMAX , f , c} ( j ) > {P}_{CMAX , f , c} ( 1 ) ,$$

then p_{t,j} can be larger than p_{t,1}, and so this is a contradiction.

For Case 2 in which the UE 104 does not compensate the insertion loss,

$${p}_{t , j} = {p}_{t , 1} - {δ}_{1 , j} ,$$

where, as noted above

$${δ}_{l , j} = {P}_{CMAX , f , c} ( 1 ) - {P}_{CMAX , f , c} ( j ) = Δ {T}_{RxSRS , j}^{A} - Δ {T}_{RxSRS , i}^{A} .$$

From the above, the techniques correct the SRS based channel estimates for the allowed power imbalances.

In a first step or act, the UE 104 signals the set of values δ_{1,j} for all 1≤j≤N to the NE 102 (e.g., a gNB) where N is the number of SRS ports,

$${δ}_{i , j} = {P}_{CMAX , f , c} ( i ) - {P}_{CMAX , f , c} ( j )$$

and the SRS ports are numbered such that

$${δ}_{1 , j} \geq 0 for all 1 \leq j \leq N .$$

These values are a function of the switching and trace losses and can only be signaled when there is a change in the mapping or numbering of the antenna ports.

In a second step or act, the UE 104 indicates whether or not it compensates the SRS transmit power for the i-th antenna port up to the configured maximum power for the port given by PC_{MAX,f,c}(i).

In a third step or act, for each SRS occasion, it is assumed that the UE 104 signals two of the three quantities for port 1 as defined above: i) the transmitted power p_{t,1}; ii) the maximum configured power P_{CMAX,f,c}(1); iii) the power headroom for port P_{H,1}. These three quantities have the relationship

$${P}_{CMAX , f , c} ( 1 ) = {p}_{t , 1} + {p}_{H , 1} .$$

In a fourth step or act, for a UE 104 that indicates that it compensates the SRS insertion loss for the j-th antenna port up to P_{CMAX,f,c}(1), the NE 102 (e.g., a gNB) corrects the channel estimate from δ_{1,j}, p_{t,1}, and P_{CMAX,f,c}(1) using

$${p}_{t , j} = \{ \begin{matrix}{p}_{t , 1} & {p}_{t , 1} \leq {P}_{CMAX , f , c} ( 1 ) - {δ}_{1 , j} \\ {P}_{CMAX , f , c} ( 1 ) - {δ}_{1 , j} & {p}_{t , i} > {P}_{CMAX , f , c} ( 1 ) - {δ}_{1 , j}\end{matrix} .$$

For a UE 104 indicating that is does not compensate the SRS insertion loss, the NE 102 (e.g., a gNB) corrects the channel estimate for the j-th UE antenna port from δ_{1,j} and p_{t,1} using

$${p}_{t , 1} \leq {P}_{CMAX , f , c} ( 1 ) - {δ}_{1 , j} .$$

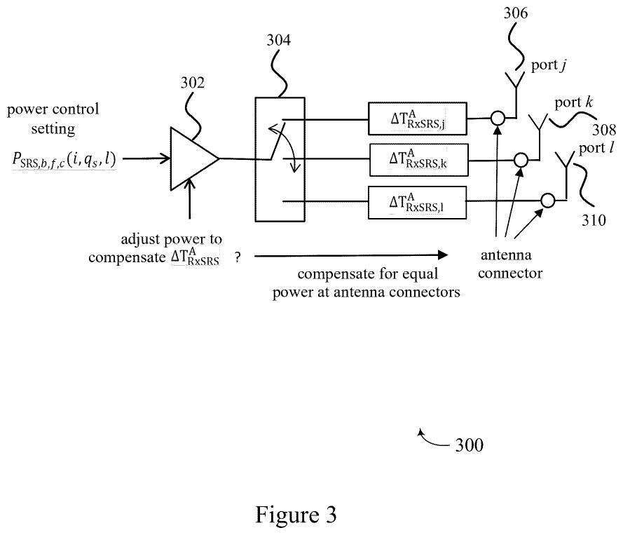

FIG. 3 illustrates an example 300 of compensation of implementation losses in accordance with aspects of the present disclosure. The example 300 illustrates compensation of

$$Δ {T}_{RxSRS}^{A}$$

implementation losses. In the example 300, the behavior of the output power versus the power control setting P_{SRS,b,f,c}(i, qₛ, l, p) in combination with the actual power relaxations

$$Δ {T}_{RxSRS}^{A}$$

is considered. The UE 104 actively compensates for losses by adjusting the power at power amplifier 302 when switching at 304 between the SRS ports (e.g., port j 306, port k 308, and port l 310), as shown in this example 300.

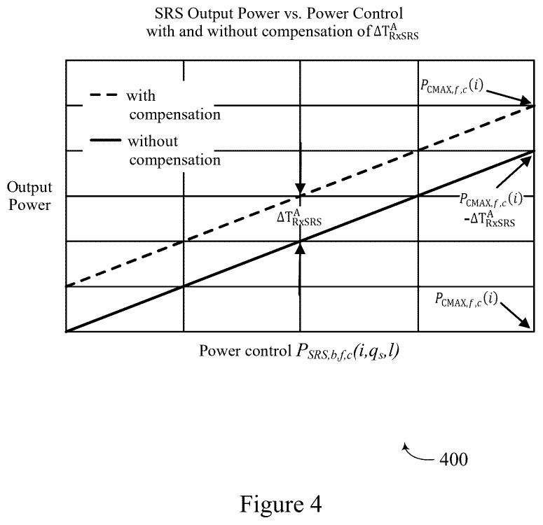

FIG. 4 illustrates an example 400 of SRS output power versus power control with and without compensation in accordance with aspects of the present disclosure. The example 400 illustrates SRS output power vs. power control with and without compensation of

$$Δ {T}_{RxSRS}^{A}$$

In the example 400, the SRS output power is shown as a function of the power control setting P_{SRS,b,f,c}(i, qₛ, l, p) both when the implementation loss

$$Δ {T}_{RxSRS}^{A}$$

is compensated and with it is not compensate. From the example 400, it can be seen that if the implementation loss is not compensated, the SRS output power is shifted down by

$$Δ {T}_{RxSRS}^{A} ,$$

and furthermore, ine maximum power at the antenna connector is reduced to

$${P}_{CMAX , f , c , p} ( i ) - Δ {T}_{RxSRS}^{A} .$$

Unless the UE 104 compensates the SRS relaxations as indicated in FIG. 3, the SRS output power will lag the power control setting P_{SRS,b,f,c}(i, qₛ, l, p) by

$$Δ {T}_{RxSRS , p}^{A} .$$

Since the maximum value of the power control setting P_{SRS,b,f,c}(i, qₛ, l, p) is P_{CMAX,f,c,p}(i), the maximum power at the antenna connector will be

$${P}_{CMAX , f , c , p} ( i ) - Δ {T}_{RxSRS , p}^{A} .$$

Since P_{CMAX,f,c,p}(i) was already reduced by ΔT_{RxSRS,p} (assuming the maximum configured power is equal to its lower bound) the reduction of P_{CMAX,f,c,p}(i) by

$$Δ {T}_{RxSRS , p}^{A}$$

without compensation by the power amplifier has the effect of reducing the maximum configured power by

$$2 \cdot Δ {T}_{RxSRS}^{A} .$$

Unless the SRS implementation loss

$$Δ {T}_{RxSRS , p}^{A}$$

is compensated oy ine UL 104, the total reduction in maximum configured power will be

$$2 \cdot Δ {T}_{RxSRS}^{A} .$$

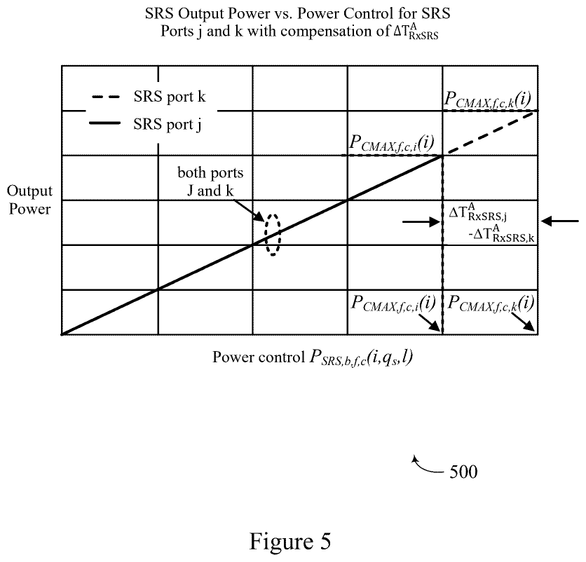

FIG. 5 illustrates an example 500 of power difference between SRS ports versus power control with compensation in accordance with aspects of the present disclosure. The example 500 illustrates power difference between SRS ports vs. power control with compensation of

$$Δ {T}_{RxSRS}^{A} .$$

In the example 500, the SRS output power is shown for SRS ports j and k as a function of the power control setting P_{SRS,b,f,c}(i, qₛ, l, p) for the case that the SRS power relaxations are compensated by the UE 104. In the example 500, P_{CMAX,f,c,j}(i) and P_{CMAX,f,c,k}(i) denote the maximum configured power for SRS ports j and k, respectively, and

$$Δ {T}_{RxSRS , j}^{A} and Δ {T}_{RxSRS , k}^{A}$$

denote the actual SRS power relaxations. From the example 500, it can be seen that there is no difference in the output power for the two SRS ports unless the power control setting is greater than PC_{MAX,f,c,j}(i). In this region, the output power for the k-th SRS port exceeds the power for the j-th port by the difference P_{SRS,b,f,c}(i, qₛ, l)−P_{CMAX,f,c,j}(i). It can also be noted that the difference in maximum power for the two SRS ports is given by

$$Δ {T}_{RxSRS , j}^{A} - Δ {T}_{RxSRS , k}^{A} .$$

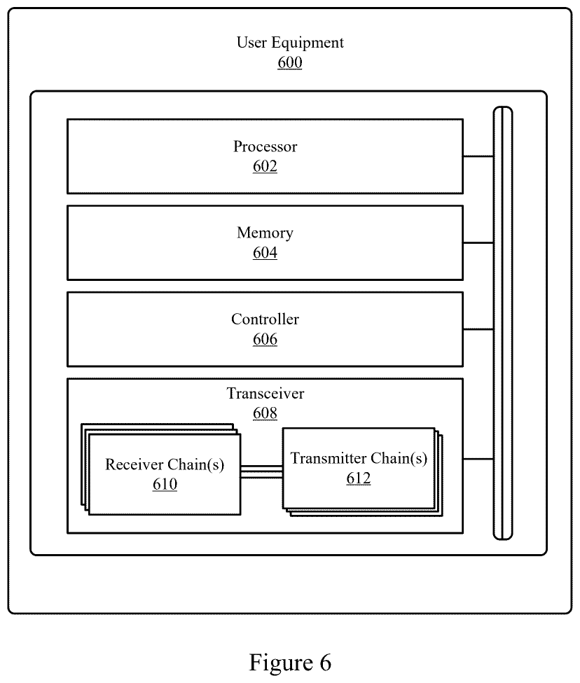

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for transmitting an indication of differences in insertion losses between a reference SRS port and each of one or more additional SRS ports; and transmitting a power headroom report for less than all SRS ports in a set of SRS ports that include the reference SRS port and the one or more additional SRS ports.

Additionally, the UE 600 may be configured to support any one or combination of where the reference SRS port comprises an SRS port of the UE having a smallest insertion loss; transmitting the power headroom report for one SRS port of the set of SRS ports having a smallest insertion loss; where the power headroom report includes a configured maximum power for the SRS port having the smallest insertion loss; where the indication of differences in insertion losses comprises differences in insertion losses between the reference SRS port and each of the one or more additional ports; where the indication of differences in insertion losses comprises differences in configured maximum power values between the reference SRS port and each of the one or more additional ports; transmitting an identity of the SRS reference port; transmitting, in response to a change in SRS port mappings, an updated indication of differences in insertion losses between the reference SRS port and each of one or more additional SRS ports.

Additionally, or alternatively, the UE 600 may support at least one memory (e.g., the memory 604) and at least one processor (e.g., the processor 602) coupled with the at least one memory and configured to cause the UE to: transmit an indication of differences in insertion losses between a reference SRS port and each of one or more additional SRS ports; transmit a power headroom report for less than all SRS ports in a set of SRS ports that include the reference SRS port and the one or more additional SRS ports.

Additionally, the UE 600 may be configured to support any one or combination of the at least one processor is configured to where the reference SRS port comprises an SRS port of the UE having a smallest insertion loss; transmit the power headroom report for one SRS port of the set of SRS ports having a smallest insertion loss; where the power headroom report includes a configured maximum power for the SRS port having the smallest insertion loss; where the indication of differences in insertion losses comprises differences in insertion losses between the reference SRS port and each of the one or more additional ports; where the indication of differences in insertion losses comprises differences in configured maximum power values between the reference SRS port and each of the one or more additional ports; transmit an identity of the SRS reference port; transmit, in response to a change in SRS port mappings, an updated indication of differences in insertion losses between the reference SRS port and each of one or more additional SRS ports.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

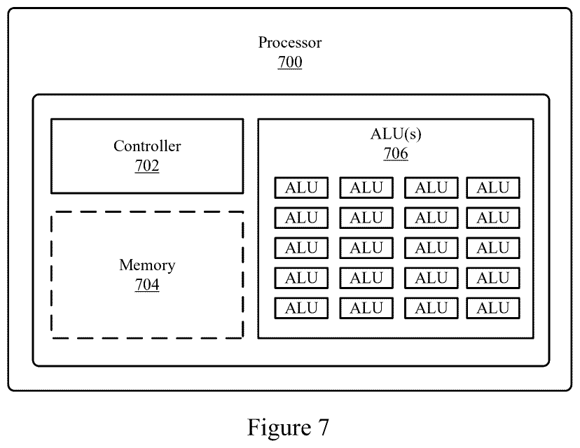

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to: transmit an indication of differences in insertion losses between a reference SRS port and each of one or more additional SRS ports; transmit a power headroom report for less than all SRS ports in a set of SRS ports that include the reference SRS port and the one or more additional SRS ports.

Additionally, the processor 700 may be configured to or operable to support any one or combination of the at least one controller is configured to cause the processor to where the reference SRS port comprises an SRS port, of a UE that includes the processor, having a smallest insertion loss; transmit the power headroom report for one SRS port of the set of SRS ports having a smallest insertion loss; where the power headroom report includes a configured maximum power for the SRS port having the smallest insertion loss; where the indication of differences in insertion losses comprises at least one of differences in insertion losses between the reference SRS port and each of the one or more additional ports, or differences in insertion losses comprises differences in configured maximum power values between the reference SRS port and each of the one or more additional ports; where the at least one controller is further configured to cause the processor to transmit an identity of the SRS reference port; transmit, in response to a change in SRS port mappings, an updated indication of differences in insertion losses between the reference SRS port and each of one or more additional SRS ports.

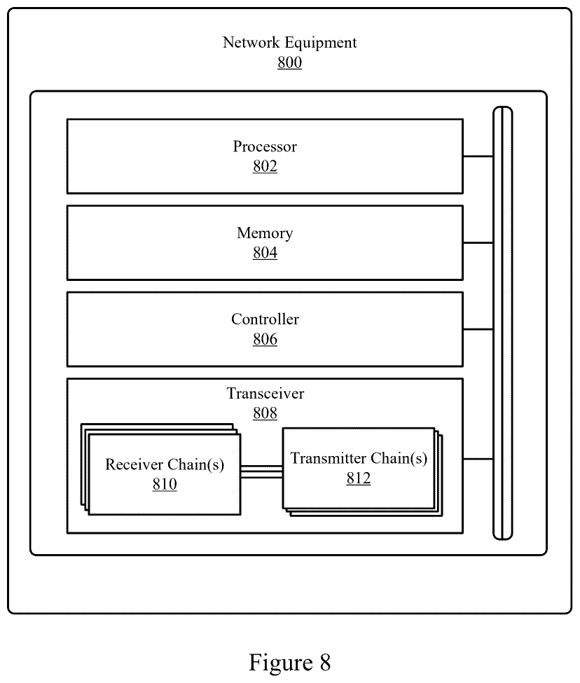

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for receiving an indication of differences in insertion losses between a reference SRS port of a UE and each of one or more additional SRS ports of the UE; receiving a power headroom report for less than all SRS ports in a set of SRS ports that include the reference SRS port and the one or more additional SRS ports.

Additionally, the NE 800 may be configured to support any one or combination of receiving the power headroom report for one SRS port of the set of SRS ports having a smallest insertion loss; where the indication of differences in insertion losses comprises at least one of differences in insertion losses between the reference SRS port and each of the one or more additional ports, or differences in insertion losses comprises differences in configured maximum power values between the reference SRS port and each of the one or more additional ports; where the reference SRS port comprises an SRS port of the UE having a smallest insertion loss; where the power headroom report includes a configured maximum power for the SRS port having the smallest insertion loss; where the indication of differences in insertion losses comprises differences in insertion losses between the reference SRS port and each of the one or more additional ports; receiving an identity of the SRS reference port; receiving, in response to a change in SRS port mappings, an updated indication of differences in insertion losses between the reference SRS port and each of one or more additional SRS ports.

Additionally, or alternatively, the NE 800 may support at least one memory (e.g., the memory 804) and at least one processor (e.g., the processor 802) coupled with the at least one memory and configured to cause the NE to: receive an indication of differences in insertion losses between a reference SRS port of a UE and each of one or more additional SRS ports of the UE; receive a power headroom report for less than all SRS ports in a set of SRS ports that include the reference SRS port and the one or more additional SRS ports.

Additionally, the NE 800 may be configured to support any one or combination of the at least one processor is configured to cause the NE to receive the power headroom report for one SRS port of the set of SRS ports having a smallest insertion loss; where the indication of differences in insertion losses comprises at least one of differences in insertion losses between the reference SRS port and each of the one or more additional ports, or differences in insertion losses comprises differences in configured maximum power values between the reference SRS port and each of the one or more additional ports; where the reference SRS port comprises an SRS port of the UE having a smallest insertion loss; where the power headroom report includes a configured maximum power for the SRS port having the smallest insertion loss; where the indication of differences in insertion losses comprises differences in insertion losses between the reference SRS port and each of the one or more additional ports; transmit an identity of the SRS reference port; transmit, in response to a change in SRS port mappings, an updated indication of differences in insertion losses between the reference SRS port and each of one or more additional SRS ports.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

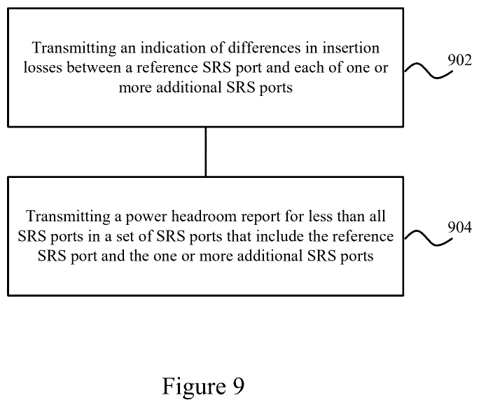

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include transmitting an indication of differences in insertion losses between a reference SRS port and each of one or more additional SRS ports. The operations of 902 may be performed in accordance with examples as described herein. In some implementations, aspects of the operations of 902 may be performed by a UE as described with reference to FIG. 6.

At 904, the method may include transmitting a power headroom report for less than all SRS ports in a set of SRS ports that include the reference SRS port and the one or more additional SRS ports. The operations of 904 may be performed in accordance with examples as described herein. In some implementations, aspects of the operations of 904 may be performed by a UE as described with reference to FIG. 6.

It should be noted that the method described herein describes a possible implementation, and that the operations and the steps may be rearranged or otherwise modified and that other implementations are possible.

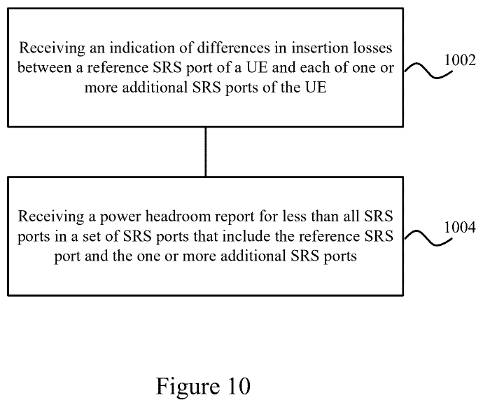

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At 1002, the method may include receiving an indication of differences in insertion losses between a reference SRS port of a UE and each of one or more additional SRS ports of the UE. The operations of 1002 may be performed in accordance with examples as described herein. In some implementations, aspects of the operations of 1002 may be performed by a NE as described with reference to FIG. 8.

At 1004, the method may include receiving a power headroom report for less than all SRS ports in a set of SRS ports that include the reference SRS port and the one or more additional SRS ports. The operations of 1004 may be performed in accordance with examples as described herein. In some implementations, aspects of the operations of 1004 may be performed by a NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit an indication of differences in insertion losses between a reference sounding reference signal (SRS) port and each of one or more additional SRS ports;
transmit a power headroom report for less than all SRS ports in a set of SRS ports that include the reference SRS port and the one or more additional SRS ports.

2. The UE of claim 1, wherein the reference SRS port comprises an SRS port of the UE having a smallest insertion loss.

3. The UE of claim 1, wherein the at least one processor is further configured to cause the UE to transmit the power headroom report for one SRS port of the set of SRS ports having a smallest insertion loss.

4. The UE of claim 3, wherein the power headroom report includes a configured maximum power for the SRS port having the smallest insertion loss.

5. The UE of claim 1, wherein the indication of differences in insertion losses comprises differences in insertion losses between the reference SRS port and each of the one or more additional ports.

6. The UE of claim 1, wherein the indication of differences in insertion losses comprises differences in configured maximum power values between the reference SRS port and each of the one or more additional ports.

7. The UE of claim 1, wherein the at least one processor is further configured to cause the UE to transmit an identity of the SRS reference port.

8. The UE of claim 1, wherein the at least one processor is further configured to cause the UE to transmit, in response to a change in SRS port mappings, an updated indication of differences in insertion losses between the reference SRS port and each of one or more additional SRS ports.

9. A processor for wireless communication, comprising:
at least one controller coupled with at least one memory and configured to cause the processor to:
transmit an indication of differences in insertion losses between a reference sounding reference signal (SRS) port and each of one or more additional SRS ports;
transmit a power headroom report for less than all SRS ports in a set of SRS ports that include the reference SRS port and the one or more additional SRS ports.

10. The processor of claim 9, wherein the reference SRS port comprises an SRS port, of a user equipment (UE) that includes the processor, having a smallest insertion loss.

11. The processor of claim 9, wherein the at least one controller is further configured to cause the processor to transmit the power headroom report for one SRS port of the set of SRS ports having a smallest insertion loss.

12. The processor of claim 11, wherein the power headroom report includes a configured maximum power for the SRS port having the smallest insertion loss.

13. The processor of claim 9, wherein the indication of differences in insertion losses comprises at least one of differences in insertion losses between the reference SRS port and each of the one or more additional ports, or differences in insertion losses comprises differences in configured maximum power values between the reference SRS port and each of the one or more additional ports.

14. The processor of claim 9, wherein the at least one controller is further configured to cause the processor to transmit an identity of the SRS reference port.

15. The processor of claim 9, wherein the at least one controller is further configured to cause the processor to transmit, in response to a change in SRS port mappings, an updated indication of differences in insertion losses between the reference SRS port and each of one or more additional SRS ports.

16. A base station for wireless communication, comprising:
at least one memory; and
at least one processor coupled with the at least one memory and configured to cause the base station to:
receive an indication of differences in insertion losses between a reference sounding reference signal (SRS) port of a user equipment (UE) and each of one or more additional SRS ports of the UE;
receive a power headroom report for less than all SRS ports in a set of SRS ports that include the reference SRS port and the one or more additional SRS ports.

17. The base station of claim 16, wherein the at least one processor is further configured to cause the base station to receive the power headroom report for one SRS port of the set of SRS ports having a smallest insertion loss.

18. The base station of claim 16, wherein the indication of differences in insertion losses comprises at least one of differences in insertion losses between the reference SRS port and each of the one or more additional ports, or differences in insertion losses comprises differences in configured maximum power values between the reference SRS port and each of the one or more additional ports.

19. A method performed by a user equipment (UE), the method comprising:
transmitting an indication of differences in insertion losses between a reference sounding reference signal (SRS) port and each of one or more additional SRS ports; and
transmitting a power headroom report for less than all SRS ports in a set of SRS ports that include the reference SRS port and the one or more additional SRS ports.

20. The method of claim 19, wherein the reference SRS port comprises an SRS port of the UE having a smallest insertion loss.
